(19) United States
(12) Patent Application Publication
(10) Pub. No.: US 2004/0099079 A1
(43) Pub. Date: May 27, 2004

(54) Manually operated gear box for commercial vehicles

(76) Inventor: Gerhard Fuhrer, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/380,091

(22) PCT Filed: Sep. 4, 2001
(86) PCT No.: PCT/EP01/10147

(30) Foreign Application Priority Data
Sep. 9, 2000 (DE) 100446027

(51) Int. Cl. F16H 63/30

(52) U.S. Cl. 74/473.25; 74/473.1

(57) ABSTRACT

A manually operated transmission, for commercial vehicles having a plurality of synchronized forward gears and one unsynchronized reverse gear and optionally one unsynchronized crawler gear with synchronizer packets for the forward gears and locking plates, has a locking part (3) upon the gearshift bar (1) for the unsynchronized reverse gear or the gearshift bar for the unsynchronized crawler gear disposed in a manner such that when selecting the gate for the reverse gear or the crawler gear it engages without force in the adjacent gearshift bar (1) for one of the synchronized forward gears so that they are driven along in the shifting direction and thereby an ansynchronization of the forward gear adjacent to the gearshift bar (2) occurs, but a complete gearshift of the forward gear is prevented.

According to the preamble of claim 1, the instant invention relates to a manually operated transmission for commercial vehicles which has a plurality of synchronized forward gears and one unsynchronized reverse gear and optionally one unsynchronized crawler gear.

Manually operated transmission with synchronizer devices are widely known. The book by Johannes Looman “Gear Transmission”, 1979, starting from page 259, thus describes synchronizer devices for mechanical transmissions having, non-rotatably situated upon a transmission shaft, a synchronizer body which on the periphery has one external gearing and several longitudinal grooves uniformly distributed, wherein an internal gearing of a sliding sleeve engages with the external gearing of the synchronizer body and thrust pieces engage with the longitudinal grooves, wherein, over a radially outer surface of each one of the thrust pieces inserted in the synchronizer body, projects a spherical locking element that interacts with a recess of the sliding sleeve and wherein the thrust pieces interact with at least one synchronizer ring having a conical friction surface and a locking gear.

In this locking synchronization, the thrust pieces situated in the longitudinal grooves of the synchronizer body serve, during a gearshift operation, to ansynchronize, that is, to move the respective synchronizer ring toward a friction surface of the adjacent clutch hub. During an upshift or a downshift, if a rotational speed difference appears between the clutch hub and the synchronizer body, a locking gearing of the synchronizer ring prevents motion of the internal gearing of the sliding sleeve into a clutch gearing of the clutch hub. Each one of the thrust pieces supports itself, via a stop pin, on a pressure spring which, in turn, is accommodated on its end by a blind hole. The stop pin has a spherical end and thus locks the sliding sleeve in a groove in its neutral position. Upon each gearshift, the pressure spring is loaded until bending, since the sliding sleeve relocates the thrust piece together with the stop pin in its axial direction while the opposite end of the pressure spring is guided into a fixed supporting part of the synchronizer body. At the moment when a synchronous rotation is obtained between the rotating parts, the sliding sleeve can be further moved, the stop pin being driven out of the groove of the sliding sleeve and thus, in addition to being bent, the pressure spring is loaded with pressure. But in the long run, said loads can result in breakage of the pressure spring.

In this known synchronizer device, the clutch gearing of the sliding sleeve is locked on the locking gearing of the synchronizer ring until no synchronization is obtained between the synchronizer body and the gear wheel. Such devices are very favorable to the driver since they do not require much attention in relation to shifting. But they also have the disadvantage that the friction device is overloaded as a consequence of the high differential speeds occurring and the often used high shifting forces and thus can wear out quickly and fail prematurely. Relatively high differential speeds have to be synchronized, particularly when shifting to the reverse gear while the vehicle still rolls forward, so that the synchronizer devices are particularly endangered in such a gearshift.

To overcome said disadvantages, the Applicant's EP B1 302 857 has already proposed a locking synchronizer device for transmission gearshifts in which a sliding sleeve carrier and a gear wheel rotating at different speeds are positively coupled together during synchronization by means of an axially movable annular sliding sleeve, a clutch gearing of the sliding sleeve engaging in each corresponding external gearing of the sliding sleeve carrier and of the clutch gearing of the gear wheel with pressure pins disposed between sliding sleeve carrier and sliding sleeve which, in an uncoupled state, engage in a recess on the inner side of the sliding sleeve and have pressure surfaces in active connection with pressure surfaces on a synchronizer ring, which is axially disposed between the sliding sleeve carrier and the gear wheel and via stops, is in synchronizing connection with peripheral play in both peripheral directions with the sliding sleeve carrier. When the differential speed subsists between the gear wheel and the sliding sleeve carrier, the locking action of the locking teeth becomes limited so that via the clutch gearing of the sliding sleeve, during axial movement thereof, the locking teeth are rotated on the synchronizer ring in a peripheral direction opposite to the sliding sleeve carrier, the locking action is limited by the reduction of the friction torque as a consequence of heating of the synchronizer ring and/or of an adequate configuration of the friction surfaces and/or of an increase in the unlocking force due to the configuration of the locking surfaces.

This known locking synchronizer device covers normal, admissible gearshifts even for the reverse gear without possibility of destruction of the synchronization due to overload. But if the forward drive, and thus the differential rotational speed between sliding sleeve and gearwheel is still too high, when trying to mesh the sliding sleeve with the clutch gearing of the gear wheel, a desired grating noise results so that the driver does not terminate the gearshift or does it only with great delay thereby preventing the engine from being damaged when thrown in gear as a consequence of the reversal of rotational speed.

In manually operated transmissions for commercial vehicles having a plurality of forward gears and one reverse gear, the same as an optionally crawler gear, all forward gears are usually synchronized whereas the reverse gear and the crawler gear are not synchronized. This is the case, for example, in the transmissions produced by the Applicant under the names ECOSPLIT or ECOMID. Therefore, to activate the reverse gear or the crawler gear, the rotating masses of the transmission have to be decelerated from the engine idling speed down to “0”, while the vehicle is stationary, before said gears can be activated without grating. In transmissions designed with low friction, the slow down time can amount up to 20 seconds. Only then is a grating-free engagement of the reverse gear or the crawler gear possible. This waiting time is felt as an impairment of the shifting comfort when using vehicles equipped with said transmissions.

The problem to be solved by this invention is to design a manually operated transmission for commercial vehicles so as to make possible quick activation of the unsynchronized reverse gear or the crawler gear possible.

Departing from a manually operated transmission of the kind specified above, the problem is solved by the feature stated in the characteristic part of the claim; advantageous developments are described in the sub-claims.

The invention provides that the gearshift bar for the unsynchronized reverse gear and/or the gearshift bar for the unsynchronized crawler gear be equipped with a locking part disposed in a manner such that, when selecting the reverse gear or the crawler gear, it engages without force in the adjacent gearshift bar for one of the synchronized forward gears so that it is positively driven along in the shifting direction and thereby an ansynchronization of the forward gear coordinated with the adjacent gearshift bar occurs, but a complete gearshift of said forward gear is prevented by a locking device.

Thereby a quick activation of the unsynchronized reverse gear or the crawler gear, specifically by ansynchronization of one other synchronizer packets, is made possible. When selecting the reverse gear gate or the crawler gear gate, the inventive locking element penetrates in the forward gearshift bar, without force, so as to be driven along in the shifting direction. The locking plate that exists in a manually operated transmission of the kind specifically mentioned above, which simultaneously prevents an activation of two gears and is coordinated with the adjacent gearshift bar for the forward gear, has been modified in such a manner that the ansynchronization of the forward gear in shifting direction of the reverse gear is made possible, but a complete gear shift is prevented. The locking part is obviously to be conformed to the conditions of the masses to be decelerated or of the desired deceleration time.

The invention is explained in detail herebelow with reference to the drawing showing an advantageous embodiment in relation to an unsynchronized reverse gear. The drawing shows:

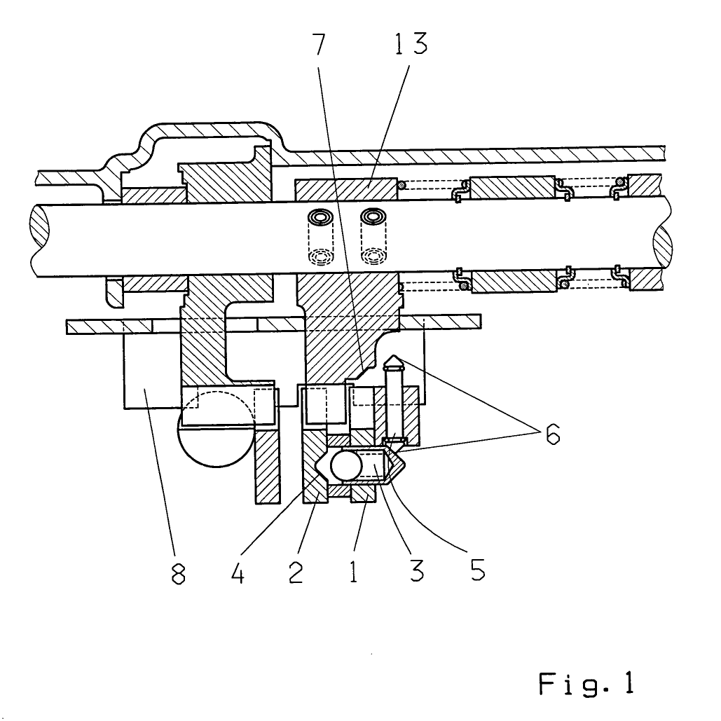

FIG. 1 is a partial sectional through an inventively designed manually operated transmission prior to ansynchronization;

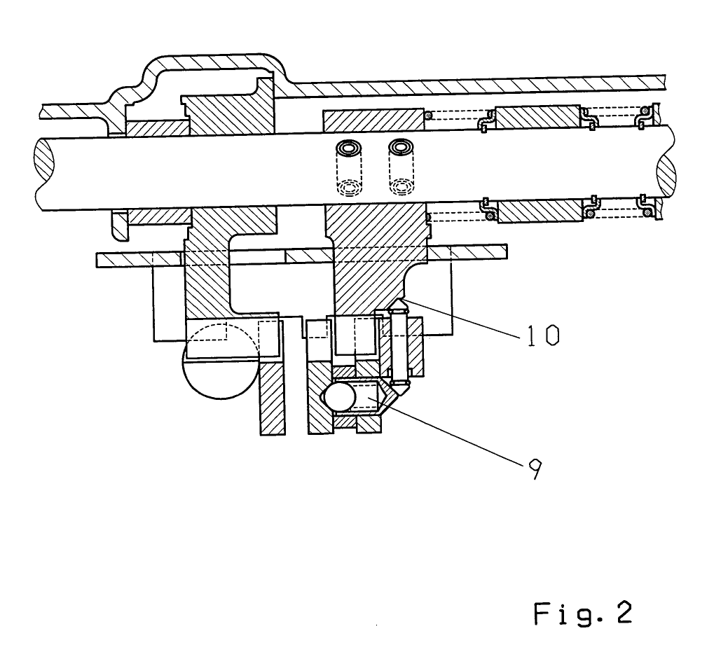

FIG. 2 is said partial view after the ansynchronization; and

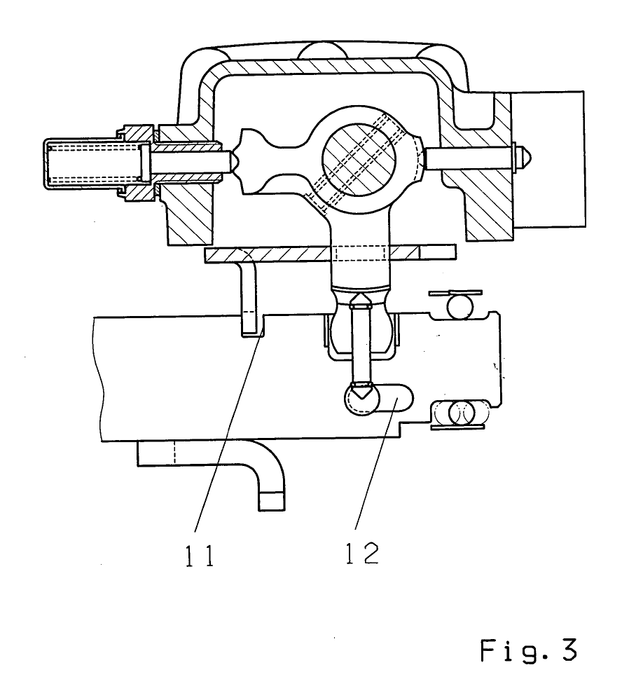

FIG. 3 is a part section through the manually operated transmission offset by 90° thereto.

In the Figures and in the descriptions that follow only the parts essential for understanding the invention have been shown and described, since manually operated transmissions are well known to the expert.

In the three figures, where the same parts are to be seen with the same reference numerals, these mean:

1 the gearshift for the unsynchronized reverse gear

2 the gearshift for a synchronized forward gear

3 a fixed locking part

4 a locking contour in the gearshift bar for the synchronized forward gear

5 a stop pin

6 a control contour of the stop pin

7 a control contour of the shifting driver 13

8 a locking plate

9 an elastic part in the locking part 3

10 a contour on the shifting driver 13 for positive absorption of the detent force

11 an enlarged locking groove in the gearshift bar 2 for the synchronized forward gear in the shifting direction of the reverse gear

12 an adapted locking contour in the gearshift bar for the synchronized forward gear in order that the auxiliary synchronization is effective only activated in the reverse gear position. The locking contour is required when the reverse gear lies opposite to a synchronized gear such as the first gear as packet with the same gearshift bar.

The inventive design of the manually operated transmission makes quick activation of the unsynchronized reverse gear or of the crawler gear possible by ansynchronizing one other synchronizer packet, the latter being in the embodiment shown the synchronizer packet of the gearshift bar 2 of the synchronized forward gear adjacent to the gearshift bar for the reverse gear 1. When selecting the gate for the reverse gear, the locking part 3 penetrates into the gearshift part 2 for the synchronized forward gear, free of force, so as to be taken along in shift direction. The locking plate 8, already existing in a manually operated transmission and which simultaneously prevents the activation of two gears, is modified in the adjacent gearshift bar in a manner such that in shifting direction of the reverse gear an ansynchronization of the forward gear is made possible but the complete shifting thereof is prevented. The locking part 3 is here conformed to the dimensions of the masses to be decelerated.

### Reference Numerals

1 gearshift bar of reverse gear 8 locking plate

2 gearshift bar of forward gear 9 elastic part

3 locking part 10 contour

4 locking contour in the gearshift bar 2 11 locking groove

5 stop pin 12 locking contour

6 control contour 13 gearshift driver

7 control contour

1. Manually operated transmission for commercial vehicles which has a plurality of synchronized forward gears and one unsynchronized reverse gear and optionally one unsynchronized crawler gear wherein the forward gears are synchronized by means of synchronizer packets situated on gearshift bars and wherein with the gearshift bars are coordinated locking plates which prevent the simultaneous activation of two forward gears, characterized in that the gearshift bar (1) for the unsynchronized reverse gear and/or the gearshift bar for the unsynchronized crawler gear are/is provided with a locking part (3) disposed in a manner such that during selection of the reverse gear or of the crawler gear it engages without force in the adjacent gearshift bar (2) for one of the synchronized forward gears so as to be driven along in shifting direction whereby occurs an ansynchronization of the forward gear coordinated with the adjacent gearshift bar (2), but a complete gearshift of said forward gear is prevented.

2. Manually operated transmission according to claim 1, characterized in that said locking part (3) is provided with an elastic element (9) and that said gearshift bar (2) is provided with a locking contour (4).

3. Manually operated transmission according to any one of ht preceding claims, characterized in that said locking plate (3) of said gearshift bar (2) adjacent to said gearshift bar (1) for the unsynchronized reverse gear has a locking groove (11) dimensioned so that the ansynchronization of the forward gear in shifting direction of the reverse gear is made possible without complete gearshift.

4. Manually operated transmission according to any one of the preceding claims, characterized in that with said gearshift bar (1) for the unsynchronized reverse gear or crawler gear, a stop pin (5) is coordinated whose two ends are provided with control contours (6) which interact, on one hand, with the control contours (7, 10) of the shifting driver (13) and, on the other, with a control contour of said locking element (3).
